(19) United States
(12) Patent Application Publication
(10) Pub. No.: US 2008/0160623 A1
(43) Pub. Date: Jul. 3, 2008

(54) Method and device for bioanalyte quantification by on/off kinetics of binding complexes

(76) Inventor: Xing Su, Cupertino, CA (US)

Correspondence Address: Client 21058;c/o DARBY & DARBY P.C., P.O. BOX 770, CHURCH STREET STATION, NEW YORK, NY, 10008-0770, US

(21) Appl. No.: 11/645,814

(22) Filed: Dec. 27, 2006

(51) Int. Cl. G01F 1/00; G01F 1/56; G01N 27/06

(52) U.S. Cl. 436/94; 436/150; 436/164; 73/861

(57) ABSTRACT

An embodiment of the invention relates to a device and method for measuring small fluid volume and detecting an analyte in a sample. The device has a channel having a plurality of sensors in a wall of the channel, wherein the sensors are located along a length of the channel and are configured to detect a leading edge and a trailing edge of a volume of a fluid flowing though the channel. The sensors could be electrodes. The device could further have a binding surface on a portion of the wall of the channel and a detector in the vicinity of the wall of the channel, wherein the binding surface has molecules that bind to an analyte and the detector could be adapted to detect binding of the analyte to the binding surface.

### RELATED APPLICATIONS

None.

### FIELD OF INVENTION

The embodiments of the invention relate methods and device for accurate measurement of small sample volume and bioanalyte quantification by on/off kinetics of binding complexes. The invention transcends several scientific disciplines such as nuclear chemistry and physics, engineering, microelectronics, analytical chemistry, and medical diagnostics.

### BACKGROUND

Chemical analysis and medical diagnostics commonly use fluorescence, chemiluminescence and Raman to detect the presence of an analyte. For example, enzyme-linked immunosorbent assays (ELISA) are widely used to detect an analyte. ELISA assays are typically performed in microwell plates, and require multiple steps of adding reagents, washing the reactant plates, and applying a reaction substrate that is converted to provide a chromogenic or fluorescent signal. Furthermore, its detection limit ranges from the micromolar to picomolar. For markers with low copy numbers, more sensitive detection technology is needed.

Future clinical diagnosis requires sensitive and quantitative measurement of bio-molecules from a minute amount of a sample (say, picoliter, nanoliter or microliter). Quantitative detection of bioanalyte is to specifically measure the amount of analytes in a given volume of a complex sample; traditional method has to divide the procedure into separate steps, for example, metering the sample volume and detecting the analyte in a separate device.

FIG. 1 illustrates one type of conventional metering methods in a micro channel device. First, a liquid sample is inserted into a vertical leg of T-shaped device wherein the vertical leg has a pre-defined volume. Second, the cleaning solution that does not mix with the liquid sample is flushed though the horizontal arm of the T-shaped device. Finally, the metered amount of the liquid sample from the vertical leg of the T-shaped device is delivered to a receptacle or A detector for detecting the type of analyte present in the liquid sample.

The current methods and devices for small volume metering and detecting the presence of an analyte in a sample have multiple drawbacks. First, a metering device such as the T-shaped device of FIG. 1 can meter and deliver one fixed volume, but for metering multiple different volumes, the size of the metering device would be too big (as it requires multiple T-shaped devices) to be used in field applications or at home environment. Second, the sample to be metered and the cleaning solution in the T-shaped device of FIG. 1 have to be immiscible. Third, the current devices require a large amount of sample, which not only is infeasible for certain applications, but also hinders activities such as mixing and heating of the sample required for many analyses. Fourth, the current devices have complex structures for fluidic control and are often not self-contained. Fifth, current devices are limited by their detection sensitivity. Thus, there is a need for a miniaturized, integrated, and versatile devices for analysis of a sample suspected of containing an analyte that can perform on-site, flexible, rapid, sensitive, and/or efficient analysis.

### BRIEF DESCRIPTION OF THE DRAWINGS

FIG. 1 illustrates a conventional metering device for metering small volume of a fluid.

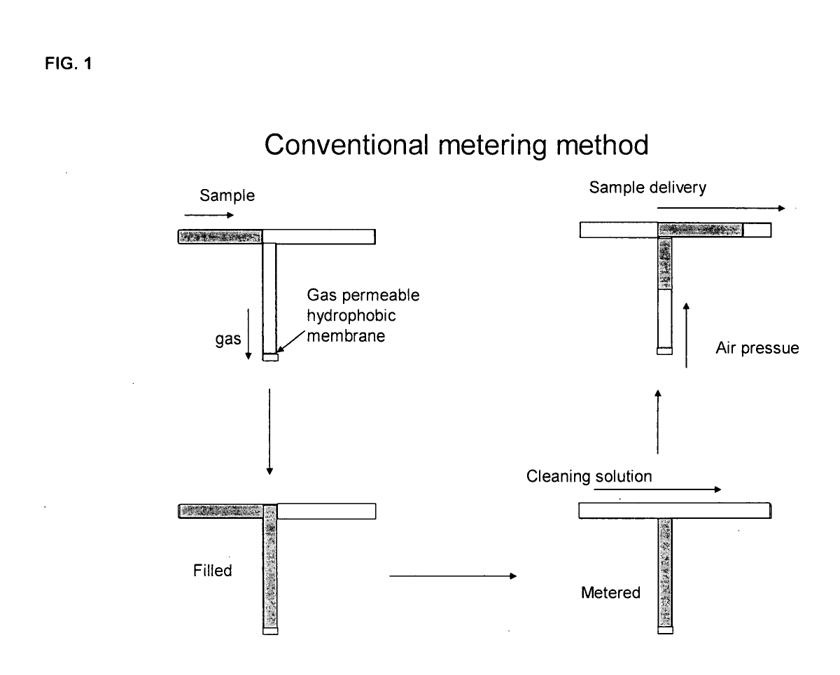

FIG. 2 illustrates a device and method for measurement of fluid type, fluid and volume of a fluid flowing through the device.

FIG. 3 illustrates a device and method for measurement of on and off binding kinetics of an analyte on a binding surface in the device.

FIG. 4. illustrates a device having channels in parallel (top) and series (bottom).

### DETAILED DESCRIPTION

The embodiments of the invention relate to a micro-channel device containing 1) a set of sensor elements to measure electrical property of liquid and its flow rate (volume), and 2) a set of affinity agents for specific analyte binding. In one embodiment, the invention is to integrate the metering step and detection step into a single device; in addition, binding kinetics of analytes on and off the binding surface are used for specific analyte quantification.

The embodiments of the invention address the problem of that exists in conventional metering method, which are inadequate for simple and precise measurements of bioanalyte in extremely low sample volume (e.g., picoliter, nanoliter or microliter). Presently, analyte in a small sample volume is estimated, but not measured, due to difficulty in handling and measuring the sample.

The technical advantages of the embodiments of the invention are that the invention provides a tool to perform small sample volume measurement and analyte detection in the same device; it offers convenience and accuracy for future clinical diagnosis involving body fluids; it enables rapid test option for many conventional diagnosis methods.

The embodiments of the invention relate to a device for detecting the presence of an analyte in a sample. The embodiments of the invention relate to analyte quantification based on rates of binding complex formation and complex dissociation under controlled fluidic conditions in an integrated microfluidic system; the fluidic conditions and their volumes are measured in real-time by a set of sensor elements. The embodiments of the invention provides a tool to perform small sample volume measurement and analyte detection in the same device; they offer convenience and accuracy for future clinical diagnosis involving body fluids; they enable rapid test option for many conventional diagnosis methods.

In other words, affinity agents are immobilized in inner surfaces of a fluidic channel or chamber and on/off rates of binding complexes are used for analyte quantification in an integrated system, where electrodes are used to monitor conductivity changes. Detection is based on distance-dependent sensing principle: for example, FET, impedance, evanescent, etc. the sensor elements can also be integrated in the device.

The embodiments of the device of the invention comprise a micro-channel device comprising a set of integrated sensor elements that measure liquid electrical properties and flow rates, a set of affinity binding agents (antibody, nucleic acid probe, aptamer, Lectins, glycans) immobilized in inner channel surfaces. The embodiments of the invention also relate to methods of detecting the presence of an analyte in a sample using the device and to methods of making the device. The embodiments of the method of the invention relate to using the device comprising priming a channel device with a buffer, passing a biological sample through the device; measuring a sample volume automatically according to fluidic boundaries, determining analyte types in the sample by positions of corresponding binding partners (probes); measuring analyte binding rates by passing a wash buffer through the device and measuring analyte dissociation rates; and undertaking data analysis (quantification of analytes) based on binding positions, binding rates and dissociation rates.

The detector of the embodiments of the invention may be part of an integrated device that also serves as a microarray or macroarray, containing an integrated circuitry component, or a microfluidic device, a MEMS, or a combination thereof. Therefore, samples contained or processed by the device may be also analyzed by the detector and/or the detection signals processed for analysis. If necessary, the signals determined by the detector may be transmitted to another device for further analysis.

As used in the specification and claims, the singular forms “a”, “an” and “the” include plural references unless the context clearly dictates otherwise. For example, the term “an array” may include a plurality of arrays unless the context clearly dictates otherwise.

The term “affinity agent” generally refers to a molecule that binds to an analyte for the detection and/or analysis of the analyte and is described in more detail below. It can be coupled to a signal particle using a functionalized polymer, for example.

A “signal particle” is a nanoparticle that is detectable by the detector of the device, and thus encompasses signal affinity complexes, signal analyte complexes, and coded magnetic signal affinity complexes, among others. In certain embodiments the signal particle is a SERS-active nanoparticle, a fluorescent nanoparticle, a nanoparticle coupled to a surface-enhanced fluorescent tag, or a core nanoparticle covalently coupled to a catalytic element. In one embodiment, the signal particle is a COIN particle. In other embodiments, the signal particle is a Qdot, or another fluorescent nanoparticle, such as SEF nanoparticle or a FluoDot. In further embodiments, the signal particle is any nanoparticle (i.e. gold, silver, CdS, CdSe, copper, Eu³⁺-coated polymer, an organic polymer (homo or hetero), an inorganic compound, or composite compounds, etc.), functionally coupled to a catalytic element. Additionally, the SERS-active nanoparticle and fluorescent nanoparticle can also be functionally coupled to a catalytic element. In certain embodiments, the sample zone of the fluidic device comprises the signal particle. Alternatively, the sample particle is contained within another fluidic zone. In further embodiments, different or the same signal particles can be contained within more than one fluidic zone.

A “signal analyte complex” refers to a signal particle functionally coupled to an analyte. An “analyte” refers to a molecule or biological cell of interest that is to be analyzed or detected using the devices and methods described herein, and is described further below.

The term “analyte specific reagent is the active ingredient of an analyte detection test. Generally, “analyte specific reagents (ASRs)” refer to antibodies, both polyclonal and monoclonal, specific receptor proteins, ligands, nucleic acid sequences, and similar reagents which, through specific binding or chemical reaction with substances in a specimen, are intended to use in a diagnostic application for identification and quantification of an individual chemical substance or ligand in biological specimens.

A “substrate” refers to a material or a combination of materials upon and/or within which other or additional materials are formed, attached, or otherwise associated with according to a predetermined fashion. A substrate often provides physical and functional support to the other or additional materials such that, together, they form part or whole of a functional device. A substrate may be a combination of two or more other substrates, which, due to the combination, have become an identifiable new substrate. In the embodiments of the invention, the substrate may comprise metal, silicon, glass, or polymeric materials.

As used in the embodiments of the invention, “associated with” is used interchangeably with “functionally coupled” and means that two or more objects are so situated that the desired results or effects are achieved.

As used herein, “dimension” or “dimensions” are the parameters or measurements required to define the shape and/or size, such as height, width, and length, of an object. As used herein, the dimension of a two-dimensional object, such as a rectangle, a polygon, or a circle, is the longest straight-line distance between any two points on the object. Therefore the dimension of a circle is its diameter; a rectangle its diagonal, and a polygon its longest diagonal. The dimension of a three-dimensional object is the longest straight-line distance between any two points on the object. The dimensions used herein are usually measured by centimeters (cm), millimeters (mm), and micrometers (μm), and nanometers (nm).

In further embodiments, the detection zone comprises a reaction substrate. A “reaction substrate” is a material or substance upon which an enzyme (such as the catalytic element) acts. The product of the reaction can be fluorogenic, chemiluminescent, or detectable by UV-visible light (such as by a color change). Non-limiting examples of reaction substrates include Lumigen APS-5, Lumigen TMA-6, Lumigen PS-atto, Lumigen PS-3, H₂O₂ with an oxidizable compound, Amplex Red, 3, 5, 3′,5′-tetramethylbenzidine (TMB), glucose, O₂, ATP, Mg²⁺, luciferin, inoluciferin, quinolinyl, coelentrazine, aldehyde, FMNH₂, and analogs and combinations thereof.

In certain embodiments, a fluorescent tag is attached to the signal particle. Non-limiting examples of suitable fluorescent tags include HcRed, green fluorescent protein, modified or enhanced green fluorescent protein, yellow fluorescent protein, enhanced yellow fluorescent protein, cyan fluorescent protein, blue fluorescent protein, red fluorescent protein, soluble-modified red-shifted green fluorescent protein, soluble-modified blue fluorescent protein; blue variant of green fluorescent protein; soluble-modified blue fluorescent protein, or analogs or combinations thereof.

In other embodiments, the signal particle is itself detectable by the detector in the absence of a catalytic element and reaction substrate. Typically, in such situation, the signal particle will comprise a SERS-active nanoparticle or a fluorescent nanoparticle, which can, for example, comprise a nanoparticle coupled to a surface-enhanced fluorescent tag. The SERS-active nanoparticle is detectable by Raman in the detection zone. The fluorescent nanoparticle can be, for example, a Qdot or other fluorescent nanoparticles, such as SEF nanoparticles or FluoDots, which are detectable by examining fluorescence in the detection zone.

Alternatively, detection of the analyte can occur by fluorescence quenching. In one embodiment, the signal particle comprises a nanoparticle coupled to an affinity agent and an ODN sequence. The detection zone contains a FRET pair of double stranded ODNs that contain donor or acceptor on one strand each, and where one of the single strands is complementary to the ODN sequence on the nanoparticle. Interaction between the ODN and the FRET pair results in a decrease in fluorescence, thus indicating the presence of the analyte.

In a further embodiment, the analyte is detected by Fluorescence Resonance Energy Transfer (FRET). FRET is an energy transfer mechanism between two fluorescent molecules. A fluorescent donor is excited at its specific fluorescence excitation wavelength. By a long-range dipole-dipole coupling mechanism, this excited state is then nonradiatively transferred to a second molecule, the acceptor, where it is then released as a photon. In one embodiment, a sandwich binding complex is formed between a magnetic particle, an analyte, and a nanoparticle coated with one partner of a FRET pair in one zone, the sandwich binding complex is moved to a second zone where another partner of the FRET pair is present, and FRET is detected.

In a further embodiment, fluorescence is detected through the use of complimentary segments of the fluorophore. Fluorogenic detection can also be employed. Time-resolved fluorescence can similarly be used in the invention. Other types of fluorescence can also be used, such as fluorescence polarization. Additionally, binding complex formation can be detected by chemiluminescence.

Binding of analyte and the binding surface is also detectable via UV-visible spectroscopy. Reflectance can be used to detect the binding. Binding can also be detected electrically, such as by current measurement (where there is oxidation and reduction or free electron production), FET or potential measurement (where there is net or local charge changes), or by CHEM-FET, surface plasmon resonance, mass spectroscopy, interferometry, or radioactivity. These methods of detection are merely non-limiting examples of the many possible methods of detecting the presence of a binding in the vicinity of the detector.

The use of fluidic devices to conduct biomedical assays has many significant advantages. First, because the volume of fluids within the fluidic zones is very small, usually several nano-liters, the amount of reagents and analytes required for the assays is quite small. This is especially significant for expensive reagents. The fabrications techniques used to construct these fluidic devices, discussed in more details herein, are relatively inexpensive and are very amenable both to highly elaborated, multiplexed devices and also to mass production, such as in an integrated circuit die. In manners similar to that for microelectronics, fluidic technologies also enable the fabrication of highly integrated devices for performing different functions on the same substrate chip. Embodiments of the invention helps create integrated, portable clinical diagnostic devices for home and bedside use, thereby eliminating time consuming laboratory analysis procedures. Additionally, certain embodiments of the invention are self-contained such that liquid does not flow through the fluidic zones, thereby eliminating the need for flow controllers. In such embodiments, the magnetic particles and any molecules bound to the magnetic particles are moved through the liquid contained within the fluidic zones by activating the magnetic microcoils, and are not moved by the flow of the liquid. Typically in these embodiments, the fluid is present in the fluidic zones to act as a suspending agent. Other embodiments of the invention comprise a flow controller for coordinating liquid flow through the fluidic zones of the device. In such embodiments, the magnetic particles and any molecules bound to the magnetic particles are moved through the fluidic zones by activating the magnetic microcoils and/or also can be moved by activating the flow controller to move the liquid itself.

An “array,” “macroarray” or “microarray” is an, intentionally created collection of substances, such as molecules, openings, microcoils, detectors and/or sensors, attached to or fabricated on a substrate or solid surface, such as glass, plastic, silicon chip or other material forming an array. The arrays can be used to measure the expression levels of large numbers, e.g., tens, thousands or millions, of reactions or combinations simultaneously. An array may also contain a small number of substances, e.g., one, a few or a dozen. The substances in the array can be identical or different from each other. The array can assume a variety of formats, e.g., libraries of soluble molecules; libraries of compounds tethered to resin beads, silica chips, or other solid supports. The array could either be a macroarray or a microarray, depending on the size of the pads on the array. A macroarray generally contains pad sizes of about 300 microns or larger and can be easily imaged by gel and blot scanners. A microarray would generally contain pad sizes of less than 300 microns.

An array of magnetic microcoils is a collection of microcoils fabricated on a substrate, such as silicon, glass, or polymeric substrate. Each of the microcoils may be associated with or functionally coupled to the fluidic device containing fluidic zones, across which the microcoil is capable of generating a magnetic field as part of a biomedical assay. The fluidic zones may be a space for holding a liquid sample and/or a surface for immobilizing certain molecules, such as DNAs and proteins. The microcoil arrays may be a microarray or a macroarray depending on the sizes or the microcoils and the associated sample spaces. In one embodiment, the microcoil array is programmably activatable such that individual members or groups of the array turn on and off in a coordinated manner in order to move the magnetic particles (and any compounds or molecules attached to the magnetic particles) from one fluidic zone to another fluidic zone. As used herein, “move” refers to changing the position of the magnetic particle, and includes concentrating and dispersing the particles as well as re-locating the particles within a fluidic zone and/or from one fluidic zone to another fluidic zone.

A DNA microarray is a collection of microscopic DNA spots attached to a solid surface forming an array. DNA microarrays can be used to measure the expression levels of large numbers of genes simultaneously. In a DNA microarray, the affixed DNA segments are known as probes, thousands of which can be used in a single DNA microarray. Measuring gene expression using microarrays is relevant to many areas of biology and medicine, such as studying treatments, disease and developmental stages.

“Solid support” and “support” refer to a material or group of materials having a rigid or semi-rigid surface or surfaces. In some aspects, at least one surface of the solid support will be substantially flat, although in some aspects it may be desirable to physically separate synthesis regions for different molecules with, for example, wells, raised regions, pins, etched trenches, or the like. In certain aspects, the solid support(s) will take the form of beads, resins, gels, microspheres, or other geometric configurations.

The term “molecule” generally refers to a macromolecule or polymer as described herein. However, channels or arrays comprising single molecules, as opposed to macromolecules or polymers, are also within the scope of the embodiments of the invention.

A “macromolecule” or “polymer” comprises two or more monomers covalently joined. The monomers may be joined one at a time or in strings of multiple monomers, ordinarily known as “oligomers.” Thus, for example, one monomer and a string of five monomers may be joined to form a macromolecule or polymer of six monomers. Similarly, a string of fifty monomers may be joined with a string of hundred monomers to form a macromolecule or polymer of one hundred and fifty monomers. The term polymer as used herein includes, for example, both linear and cyclic polymers of nucleic acids, polynucleotides, polysaccharides, oligosaccharides, proteins, polypeptides, peptides, phospholipids and peptide nucleic acids (PNAs). The peptides include those peptides having either α-, β-, or ω-amino acids. In addition, polymers include heteropolymers in which a known drug is covalently bound to any of the above, polyurethanes, polyesters, polycarbonates, polyureas, polyamides, polyethyleneimines, polyarylene sulfides, polysiloxanes, polyimides, polyacetates, or other polymers which will be apparent upon review of this disclosure.

The term “biomolecule” refers to any organic molecule that is part of or from a living organism. Biomolecules include a nucleotide, a polynucleotide, an oligonucleotide, a peptide, a protein, a ligand, an antibody, a receptor, among others. A “complex of a biomolecule” refers to a structure made up of two or more types of biomolecules. Examples of a complex of biomolecule include a cell or viral particles.

As used herein, “biological cells” and “cells” are interchangeable, unless otherwise clearly indicated, and refer to the structural and functional units of all living organisms, sometimes called the “building blocks of life.” Cells, as used herein include bacteria, fungi, and animal mammalian cells. Specifically included are animal blood cells, such as red blood cells, white blood cells, and platelets.

The term “analyte” or “analyte molecule” refers to a molecule or biological cell of interest that is to be analyzed or detected, e.g., a nucleotide, an oligonucleotide, a polynucleotide, a peptide, a protein, an antibody, or a blood cell. Examples of analytes that can be investigated by this invention include, but are not restricted to, agonists and antagonists for cell membrane receptors, toxins and venoms, viral epitopes, hormones, hormone receptors, peptides, enzymes, enzyme reaction substrates, cofactors, drugs (e.g. opiates, steroids, etc.), lectins, sugars, polynucleotides, nucleic acids, oligosaccharides, proteins, antibodies, and autoantibodies. The analyte or analyte molecule could be a small molecule, biomolecule, or nanomaterial such as but not necessarily limited to a small molecule that is biologically active, nucleic acids and their sequences, peptides and polypeptides, as well as nanostructure materials chemically modified with biomolecules or small molecules capable of binding to molecular probes such as chemically modified carbon nanotubes, carbon nanotube bundles, nanowires and nanoparticles. The analyte may be magnetically tagged, or labeled to facilitate its detection and separation.

The term “affinity agent” refers to a molecule that binds to an analyte for the detection and/or analysis of the analyte. The affinity agent generally, but not necessarily, has a known molecular structure or sequence. In one embodiment, the affinity agent is attached to a solid surface of the fluidic device. When the affinity agent is attached to a solid surface, it is referred to as an “affinity surface”. In another embodiment, the affinity agent is attached to a magnetic particle or signal particle. When the affinity agent is attached to the magnetic particle, it is referred to as a “magnetic affinity complex”. When the affinity agent is attached to the signal particle, it is referred to as a “signal affinity complex”. In one embodiment of the signal affinity complex, the affinity agent is the analyte of interest; in such case, the signal affinity complex is termed a “signal analyte complex”. The affinity agent typically include, but are not limited to antibodies, autoantibodies, cell membrane receptors, monoclonal or polyclonal antibodies and antisera reactive with specific antigenic determinants (such as on viruses, cells or other materials), drugs, polynucleotides, nucleic acids, peptides, proteins, cofactors, lectins, sugars, polysaccharides, cells, cellular membranes, and organelles. Affinity agents are biomolecules capable of undergoing binding or molecular recognition events with analytes. An affinity agent can be a capture molecule.

The term “capture molecule” refers to a molecule that is immobilized on a surface. The capture molecule can bind to the analyte, the magnetic particle, the signal particle, the affinity agent, or the code. The capture molecule is typically a nucleotide, an oligonucleotide, a polynucleotide, a peptide, or a protein, but could also be a small molecule, biomolecule, or nanomaterial such as but not necessarily limited to a small molecule that is biologically active, nucleic acids and their sequences, peptides and polypeptides, as well as nanostructure materials chemically modified with biomolecules or small molecules capable of binding to an analyte that is bound to an affinity agent to form a complex of the capture molecule, analyte and the magnetic affinity complex and/or the signal affinity complex. The capture molecule may be magnetically or fluorescently labeled DNA or RNA. In specific embodiments of the invention, the capture molecule may be immobilized on the surface of a fluidic zone of the fluidic device. The capture molecule may or may not be capable of binding to just the analyte, or just the affinity agent.

The terms “die,” “polymer array chip,” “DNA array,” “array chip,” “DNA array chip,” or “bio-chip” are used interchangeably and refer to a collection of a large number of probes arranged on a shared substrate which could be a portion of a silicon wafer, a nylon strip or a glass slide.

Certain embodiments of the invention contemplate the use of coded magnetic particles and signal particles for detecting the presence of an analyte using the devices described herein. Typically, a sample suspected of comprising an analyte is introduced into the sample zone of the fluidic device, wherein a coded magnetic affinity complex binds to the analyte to form a coded magnetic binding complex. The microcoil array is activated to move the coded magnetic binding complex from the sample zone to a first affinity surface, where it is bound and immobilized. Typically the affinity agent on the first affinity surface is complementary to and binds to the affinity agent on the magnetic particle. The code is then detached from the coded magnetic binding complex. The detached code then binds to a magnetic signal affinity complex to form a coded magnetic signal binding complex. Typically the affinity agent of the magnetic signal affinity complex is complementary to the code. In one embodiment, the affinity agent of the magnetic signal affinity complex is a polynucleotide complementary to the code polynucleotide. The microcoil array is activated to move the coded magnetic signal binding complex to one or multiple detection zones comprising a second affinity surface. Typically different areas of the detection zone or the different detection zones contain unique affinity agents to the codes. The affinity agents of the second affinity surface are complementary to and bind the code. The detector then detects the coded magnetic signal binding complex in the detection zone using electrical sensing methods, optical sensing methods, or enzymatic methods, such as amplifying the affinity agent (if it is a polynucleotide) on the magnetic signal affinity complex.

“Detachment” refers to the separation of the analyte from molecules such as capture molecules or affinity agents. It can be detached using any method known to those of skill in the art. In one embodiment, it is detached by heating. In other embodiments, it is enzymatically detached.

The term “nucleotide” includes deoxynucleotides, ribonucleotides and analogs thereof. These analogs are those molecules having some structural features in common with a naturally occurring nucleotide such that when incorporated into a polynucleotide sequence, they allow hybridization with a complementary polynucleotide in solution. Typically, these analogs are derived from naturally occurring nucleotides by replacing and/or modifying the base, the ribose or the phosphodiester moiety. The changes can be tailor-made to stabilize or destabilize hybrid formation, or to enhance the specificity of hybridization with a complementary polynucleotide sequence as desired, or to enhance stability of the polynucleotide.

The term “polynucleotide” or “nucleic acid” as used herein refers to a polymeric form of nucleotides of any length, either ribonucleotides or deoxyribonucleotides, that comprise purine and pyrimidine bases, or other natural, chemically or biochemically modified, non-natural, or derivatized nucleotide bases. Polynucleotides of the embodiments of the invention include sequences of deoxyribopolynucleotide (DNA), ribopolynucleotide (RNA), or DNA copies of ribopolynucleotide (cDNA) which may be isolated from natural sources, recombinantly produced, or artificially synthesized. A further example of a polynucleotide of the embodiments of the invention may be polyamide polynucleotide (PNA). The polynucleotides and nucleic acids may exist as single-stranded or double-stranded. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. The polymers made of nucleotides such as nucleic acids, polynucleotides and polynucleotides may also be referred to herein as “nucleotide polymers.

When the biomolecule or macromolecule of interest is a peptide, the amino acids can be any amino acids, including α, β, or ω-amino acids. When the amino acids are α-amino acids, either the L-optical isomer or the D-optical isomer may be used. Additionally, unnatural amino acids, for example, β-alanine, phenylglycine and homoarginine are also contemplated by the embodiments of the invention. These amino acids are well-known in the art.

A “peptide” is a polymer in which the monomers are amino acids and which are joined together through amide bonds and alternatively referred to as a polypeptide. In the context of this specification it should be appreciated that the amino acids may be the L-optical isomer or the D-optical isomer. Peptides are two or more amino acid monomers long, and often more than 20 amino acid monomers long.

A “protein” is a long polymer of amino acids linked via peptide bonds and which may be composed of two or more polypeptide chains. More specifically, the term protein” refers to a molecule composed of one or more chains of amino acids in a specific order; for example, the order as determined by the base sequence of nucleotides in the gene coding for the protein. Proteins are essential for the structure, function, and regulation of the body's cells, tissues, and organs, and each protein has unique functions. Examples are hormones, enzymes, and antibodies.

The term “sequence” refers to the particular ordering of monomers within a macromolecule and it may be referred to herein as the sequence of the macromolecule.

The term “hybridization” refers to the process in which two single-stranded polynucleotides bind non-covalently to form a stable double-stranded polynucleotide; triple-stranded hybridization is also theoretically possible. The resulting (usually) double-stranded polynucleotide is a “hybrid.” The proportion of the population of polynucleotides that forms stable hybrids is referred to herein as the “degree of hybridization.” For example, hybridization refers to the formation of hybrids between a probe polynucleotide (e.g., an affinity agent polynucleotide of the invention which may include substitutions, deletion, and/or additions) and a specific analyte polynucleotide wherein the probe preferentially hybridizes to the specific analyte polynucleotide and substantially does not hybridize to polynucleotides consisting of sequences which are not substantially complementary to the analyte polynucleotide. However, it will be recognized by those of skill that the minimum length of a polynucleotide desired for specific hybridization to a target polynucleotide will depend on several factors: G/C content, positioning of mismatched bases (if any), degree of uniqueness of the sequence as compared to the population of analyte polynucleotides, and chemical nature of the polynucleotide (e.g., methylphosphonate backbone, phosphorothiolate, etc.), among others.

Methods for conducting polynucleotide hybridization assays have been well developed in the art. Hybridization assay procedures and conditions will vary depending on the application and are selected in accordance with the general binding methods known in the art.

It is appreciated that the ability of two single stranded polynucleotides to hybridize will depend upon factors such as their degree of complementarity as well as the stringency of the hybridization reaction conditions.

As used herein, “stringency” refers to the conditions of a hybridization reaction that influence the degree to which polynucleotides hybridize. Stringent conditions can be selected that allow polynucleotide duplexes to be distinguished based on their degree of mismatch. High stringency is correlated with a lower probability for the formation of a duplex containing mismatched bases. Thus, the higher the stringency, the greater the probability that two single-stranded polynucleotides, capable of forming a mismatched duplex, will remain single-stranded. Conversely, at lower stringency, the probability of formation of a mismatched duplex is increased.

The appropriate stringency that will allow selection of a perfectly-matched duplex, compared to a duplex containing one or more mismatches (or that will allow selection of a particular mismatched duplex compared to a duplex with a higher degree of mismatch) is generally determined empirically. Means for adjusting the stringency of a hybridization reaction are well-known to those of skill in the art.

The term “chip” or “microchip” refers to a small device or substrate that comprises components for performing certain functions. A chip includes substrates made from silicon, glass, metal, polymer, or combinations and capable of functioning as a microarray, a macroarray, a fluidic device, and/or an integrated circuitry component. A chip may be a microelectronic device made of semiconductor material and having one or more integrated circuits or one or more devices. A “chip” or “microchip” is typically a section of a wafer and made by slicing the wafer. A “chip” or “microchip” may comprise many miniature transistors and other electronic components on a single thin rectangle of silicon, sapphire, germanium, silicon nitride, silicon germanium, or of any other semiconductor material. A microchip can contain dozens, hundreds, or millions of electronic components. In the embodiments of the invention, as discussed herein, fluidic zones, magnetic microcoil arrays, detectors, and vibration elements can also be integrated into a microchip.

“Micro-Electro-Mechanical Systems (MEMS)” is the integration of mechanical elements, sensors, actuators, and electronics on a common silicon substrate through microfabrication technology. While the electronics are fabricated using integrated circuit (IC) process sequences (e.g., CMOS, Bipolar, or BICMOS processes), the micromechanical components could be fabricated using compatible “micromachining” processes that selectively etch away parts of the silicon wafer or add new structural layers to form the mechanical and electromechanical devices. Microelectronic integrated circuits can be thought of as the “brains” of a system and MEMS augments this decision-making capability with “eyes” and “arms”, to allow microsystems to sense and control the environment. Sensors gather information from the environment through measuring mechanical, thermal, biological, chemical, optical, and magnetic phenomena. The electronics then process the information derived from the sensors and through some decision making capability direct the actuators to respond by moving, positioning, regulating, pumping, and filtering, thereby controlling the environment for some desired outcome or purpose. Because MEMS devices are manufactured using batch fabrication techniques similar to those used for integrated circuits, unprecedented levels of functionality, reliability, and sophistication can be placed on a small silicon chip at a relatively low cost. In the embodiments of the invention, as discussed herein, MEMS devices can be further integrated with fluidic zones, diffusion barriers, magnetic microcoil arrays, detectors, and/or vibration elements, such that, together, they perform separation and detection function for biomolecules.

An “integrated circuitry component” is a processor on an integrated circuit (IC) chip. The processor may be one or more processor on one or more IC chip. The chip is typically a silicon chip with thousands of electronic components that serves as a central processing unit (CPU) of a computer or a computing device. It is typically a readable and writable memory chip, with or without contact. In certain embodiments, it can store reagent information, operation instructions and programs, and test results and data.

A “nanomaterial” as used herein refers to a structure, a device or a system having a dimension at the atomic, molecular or macromolecular levels, in the length scale of approximately 1-1000 nanometer (nm) range. Preferably, a nanomaterial has properties and functions because of the size and can be manipulated and controlled on the atomic level.

The term “complementary” refers to the topological compatibility or matching together of interacting surfaces of an analyte and its corresponding affinity agent. Thus, the affinity agent and its analyte can be described as complementary, and furthermore, the contact surface characteristics are complementary to each other. With respect to polynucleotides, sequences are complementary when they are able to hybridize to each other to form a stabilized duplex.

One embodiment of the invention relates to a device comprising a channel comprising a plurality of sensors in a wall of the channel, wherein the sensors are located along a length of the channel and are configured to detect a leading edge and a trailing edge of a volume of a fluid flowing though the channel. Preferably, the sensors comprise electrodes. The device could further comprise a binding surface on a portion of the wall of the channel and a detector in the vicinity of the wall of the channel, wherein the binding surface comprises capture molecules that bind to an analyte and the detector is adapted to detect binding of the analyte to the binding surface. Preferably, the binding surface is on a microarray located on the surface of the channel. Preferably, the detector is further adapted to detect detachment the analyte from the binding surface. Preferably, the detector comprises an optical detector, a field effect transistor (FET) detector, an impedance detector, or an evanescent detector. Preferably, the device comprises a plurality of channels connected in parallel or series. Preferably, the plurality of channels are fabricated in a chip. Preferably, the plurality of channels have a single inlet and a single outlet. Preferably, the capture molecules on the binding surface are biomolecules. Preferably, the biomolecules are DNA or RNA.

Another embodiment of the invention relates to a method comprising flowing a volume of a fluid in a device comprising a channel comprising a plurality of sensors in a wall of the channel, wherein the sensors are located along a length of the channel, detecting a leading edge and a trailing edge of the volume of the fluid flowing though the channel, and determining the volume of the fluid flowing through the channel. Preferably, the device further comprises a binding surface on a portion of the wall of the channel and a detector in the vicinity of the wall of the channel, wherein the binding surface comprises capture molecules that bind to an analyte, and the detector detects binding of the analyte to the binding surface. Preferably, the detector further detects detachment the analyte from the binding surface.

In a specific embodiment of the invention, the detector of the substrate comprises silicon, glass, a polymeric material, metal, or a combination thereof. More specifically, the detector may either comprise or be connected to an integrated circuit, a MEMS device, a microarray, a macroarray, a fluidic device, or a combination thereof. In other words, the embodiment can be integrated into or connected to a wide range of materials used in a variety of existing devices.

Silicon is a suitable material for forming micro-channels in the device of the embodiments of the invention, which could be coupled with microelectronics or other microelectromechanical systems (MEMS). It also has good stiffness, allowing the formation of fairly rigid microstructures, which can be useful for dimensional stability. In a specific embodiment of the invention, the device of the embodiments of the invention or substrate comprises an integrated circuitry element (IC), a packaged integrated circuit, and/or an integrated circuit die. For example, the substrate may be a packaged integrated circuit that comprises a microprocessor, a network processor, or other processing device. The substrate may be constructed using, for example, a Controlled Collapse Chip Connection (or “C4”) assembly technique, wherein a plurality of leads, or bond pads are internally electrically connected by an array of connection elements (e.g., solder bumps, columns).

Specific materials useful as the substrate also include, but not limited to, polystyrene, polydimethylsiloxane (PDMS), glass, chemically functionalized glass, polymer-coated glass, nitrocellulose coated glass, uncoated glass, quartz, natural hydrogel, synthetic hydrogel, plastics, metals, and ceramics. The substrate may comprise any platform or device currently used for carrying out immunoassays, DNA or protein microarray analysis. Thus, the substrate may comprise a microarray or a macroarray, a multi-well plate, a fluidic device, or a combination thereof.

In another embodiment, the device of the embodiments of the invention comprises circuitry that is capable of amplifying or processing the optical or electrical signals detected by the detector. Any suitable conventional circuits may be used and integrated into the substrate for amplifying and/or processing, including filtering, the optical or electrical signals detected and collected by the detector. The integrated circuitry may be able to generate a read-out of the optical or electrical signal independently or can be connected to an external device for generating the read-out.

In another embodiment of the invention, the sample is a liquid, a gel, a solid, a gas, or a mixture thereof. Therefore, the embodiment of the invention can accommodate samples in different physical states. In a specific embodiment, the sample is a liquid or in a liquid or solution state. In another embodiment, the sample zone comprises a reservoir, a channel, an opening, a surface, or a combination thereof. The embodiment accommodates a variety of applications in which a sample suspected of containing an analyte is to be analyzed. For example, the sample zone may be a reservoir, an opening void, or a surface that can hold a liquid sample. In such cases, the sample zone may be an open reservoir or surface, or a substantially closed void with an opening for sample input. The design of the space depends not only on the specific analysis to be done, but also on how to best situate and design the sample holding space in relation to the device of the embodiment of the invention, as discussed herein.

According another embodiment, the sample zone for holding a sample, such as a liquid sample, may also be the whole or part of a channel fabricated on the substrate. Depending on the specific requirement, the channel may be open (a trench) or closed. The channel typically comprises an inlet and an outlet, but may also comprise other openings for fluidic communication. In another embodiment, the channel comprises two or more inlets and at least one outlet such that different reactants may be introduced into the channel from different inlets and mixed at a mixing section within the channel for specific chemical reaction. Furthermore, the channel may comprise more than two inlets and more than one mixing section such that more than one reaction may occur within different sections of the channel according predetermined manners. As discussed herein, the channel is designed in consideration with its relations with the associated microcoil, detector, and vibration element to achieve the desired optical or electrical signal to detect the presence of the analyte.

In the embodiments of the invention, the sample zone of the device can accommodate a wide range of sample volume, including very small amount of samples. In one embodiment, the sample zone has a volume of from about 1.0 nL to about 1.0 mL. In another embodiment, the sample zone has a volume of from about 10 nL to about 10 μL. As understood by a person skilled in the art, actual sample volumes will depend on the nature of the analysis to be conducted, in addition to the design and dimensions of the device. In cases where the sample zone is a channel having two inlets and one outlet, the total sample zone may be substantially larger than the volume that is in proximity to a particular microcoil. For example, the total channel volume, excluding the inlets and outlet, may be about 1.0 μm while the volume in proximity to the microcoil may be about only 10 nL to 100 nL.

According to another embodiment of the invention, existing technologies can be used to construct the devices of the invention. For example, silicon process technologies can be used to construct or fabricate the device of the embodiments of the invention, such that the fluidic zones, diffusion barriers, and optionally the microcoils and vibration element can be constructed on a substrate that may also comprise an integrated circuitry component and/or microfluidic mechanisms such as flow controllers. In another embodiment, servo-mechanical components and mechanisms can be used to control the location and movement of the detector such that the desired signals are detected.

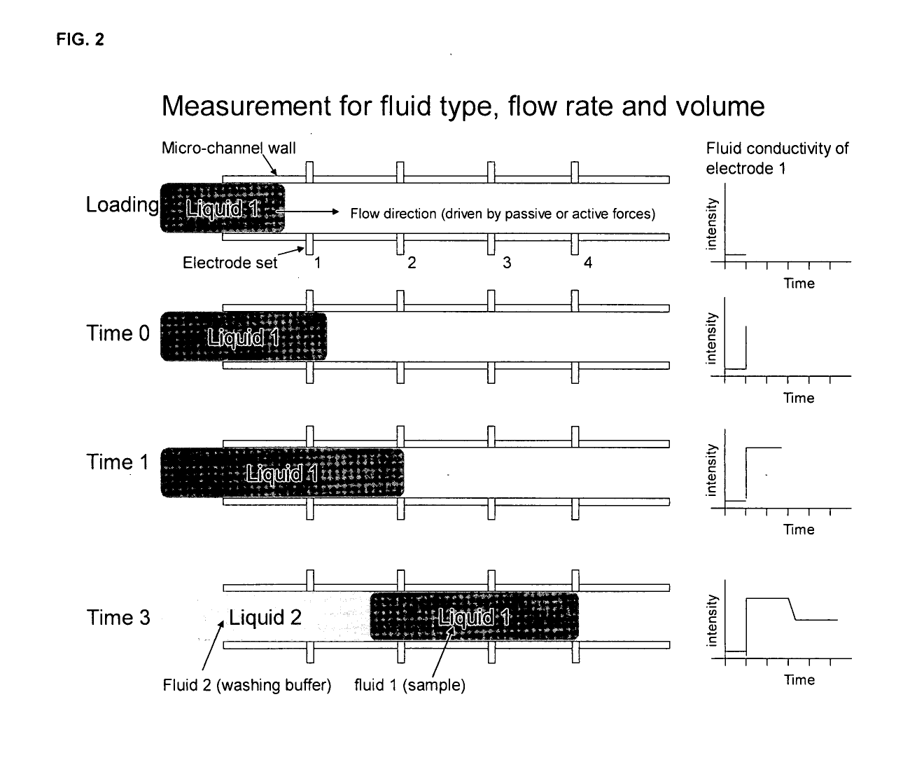

FIGS. 2-4 illustrate various embodiments of the invention.

FIG. 2 illustrates an embodiment of the invention that comprises a fluidic network having a micro-fabricated electrode array to sense liquid conductivities. The conductivities are indicators of buffer and solution types. A conductivity change indicates the boundary of 2 different liquids or buffers. Relative positions or changing rates of liquid boundaries can be used to calculate the volume of a fluid.

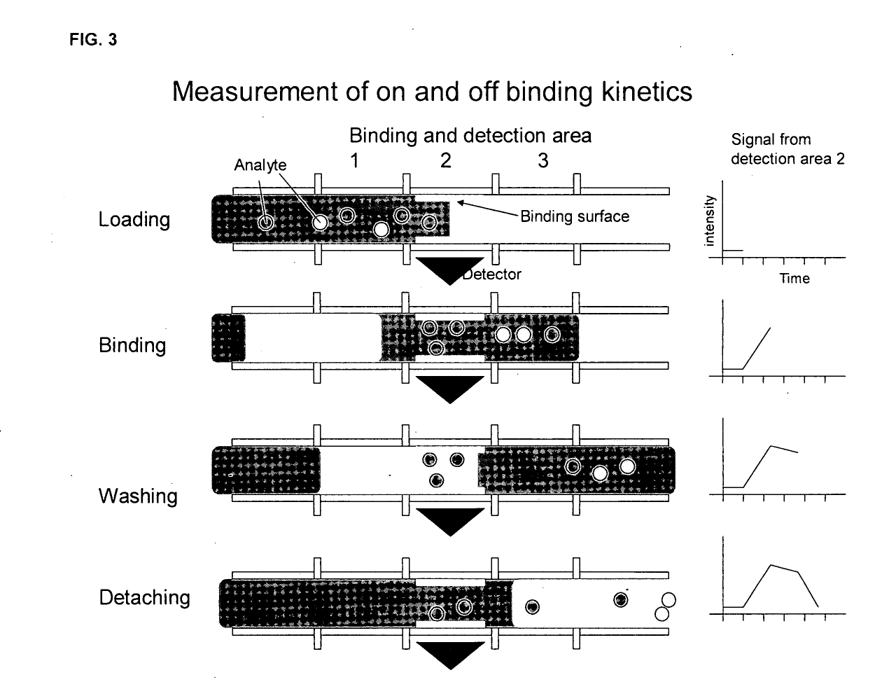

FIG. 3 illustrates the device of FIG. 2 further having a binding surface on a channel wall, and further in association with a detector, an integrated circuitry component, and is in further association with a circuit board. The device could further be connected with a circuitry component and circuit board, which collects, analyzes, and/or processes signals detected by the detector. FIG. 3 illustrates that affinity agents or capture molecules can be immobilized on the inner surface of the channels that are coupled with detectors. The detectors can be either optical or electrical. In a test, the sample containing analytes is passed through the channel and the sample volume is measured. The binding rate of the analyte with affinity agent is determined when the sample is passing through the binding site. After sample loading, wash or cleaning buffer can be applied, dissociation rates of the binding complexes are also measured. Binding rate and release (dissociation) rates are used for quantification. Preferably, signal is distance-dependent, meaning that only analytes or associated nanoparticles that are captured on the surface can generate signals.

FIG. 3 (left) shows different stages of the method for the determination of on and off binding kinetics. The first schematic from the top shows the loading of the microfluidic channel with a fluid containing an analyte, e.g., a bioanalyte. The graphs on the right show the signal diction from area 2. The first graph from the top shows that initially, during loading of the fluid containing the analyte particles, the signal measured by the detector is substantially near zero, reflecting the background noise. The second schematic from the top shows binding of the analyte to the binding area. During binding of the analyte particles to the binding area in area 2 in the vicinity of the detector, the signal increases dramatically. The third schematic from the top shows washing of the analyte particles with a first buffer liquid, which is typically a buffer liquid having a high salt concentration greater than 100 millimolar, more preferably, 100-500 millimolar. During washing, the analyte particles that are partially bound to the binding area, e.g., partially hybridized DNA, are washed away. Thus, the third graph from the top shows a slight drop in the signal intensity. Finally, the bottom schematic shows detachment step when a second buffer liquid, typically having a low salt concentration, e.g., water, is used for detaching the analyte particles attached to the molecules of the binding area. During the detachment step, the signal intensity drops substantially close to zero as shown in the graph at the bottom right of FIG. 3.

By the method of FIG. 3, which is based on the binding and de-binding (detachment) kinetics, it is possible (1) to determine how of a an unknown DNA or RNA is present in a sample containing a mixture of known and unknown DNA or RNA; (2) to detect mutation or genotype; (3) to remove background noise due to non-specific binding that might be present due to other factors besides binding or hybridization.

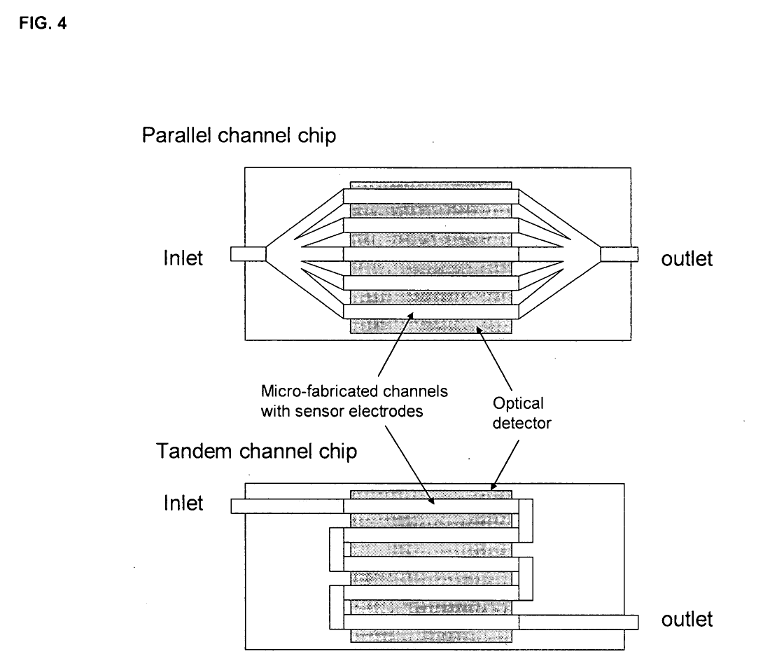

FIG. 4 illustrates that the channels in the device can be arranged in tandem or in parallel; the channels can be micro fabricated on a substrate that is plastic, glass, silicon or metal. Electrodes or sensor elements are integrated in the device and affinity agents are immobilized on the channel surfaces.

To facilitate biomolecule detection, aggregated or concentrated particles in the fluidic zones may need to be dispersed or resuspended in solution locally within in a fluidic zone. Dispersing can be achieved by mechanical means, e.g., the vibrational device such as ultrasounds (acoustic), piezo vibrations. The dispersing elements can be functionally coupled to the nBMA device (integrated with chip or the control device).

The detector is situated in proximity to the binding surface. The detector can be an optical detector or an electrical detector. In certain embodiments, the optical detector is selected from a Raman detector, a photon multiplier tube, a fluorescent reader, or an electrochemical sensor and the electrical detector is selected from a FET element, a capacity detector, a current sensor, and a charge sensor. Typically, the detection of the binding complex or the signal analyte complex indicates the presence of the analyte.

In certain embodiments the signal particle is a SERS-active nanoparticle, a fluorescent nanoparticle, a nanoparticle coupled to a surface-enhanced fluorescent tag, or a core nanoparticle covalently coupled to a catalytic element. In one embodiment, the signal particle is a COIN particle. In other embodiments, the signal particle is a Qdot, or another fluorescent nanoparticle, such as SEF nanoparticle or a FluoDot. In further embodiments, the signal particle is any nanoparticle (i.e. gold, silver, CdS, CdSe, copper, Eu³⁺-coated polymer, an organic polymer (homo or hetero), an inorganic compound, or composite compounds, etc.), functionally coupled to a catalytic element. Additionally, the SERS-active nanoparticle and fluorescent nanoparticle can also be functionally coupled to a catalytic element. In certain embodiments, the sample zone of the fluidic device comprises the signal particle. Alternatively, the sample particle is contained within another fluidic zone. In further embodiments, different or the same signal particles can be contained within more than one fluidic zone.

Typically the analyte is a protein, an antibody or a nucleic acid. In one embodiment, the analyte comprises an anti-PSA antibody. In a further embodiment, the signal affinity complex comprises a COIN-PSA conjugate. The magnetic affinity complex can comprise a SA-coated magnetic bead. The analyte can comprise an antibody, which includes an autoantibody.

As disclosed herein, compound and molecules suitable for analysis by the embodiments of the invention include proteins, peptides, and, specifically, nucleic acids (DNA and RNA), which can form double-stranded molecules by hybridization, that is, complementary base pairing. For example, in an embodiment of the invention, a molecular probe, such as a DNA probe, is associated with or attached to a fluidic zone, which is located near or on the surface of, or otherwise integrated into, the substrate. The specificity of nucleic acid hybridization from the binding of the analyte to the molecular probe is such that the detection of molecular and/or nanomaterials binding events can be done through measurements of the signals by the detector or other external circuitry. This specificity of complementary base pairing also allows thousands of hybridization to be carried out simultaneously in the same experiment on a DNA chip (also called a DNA array).

Molecular probes are immobilized on the surface of individual or individually addressable reservoirs through surface functionalization techniques. The probe in a DNA chip is usually hybridized with a complex RNA or cDNA target (the analyte) generated by making DNA copies of a complex mixture of RNA molecules derived from a particular cell type (source). The composition of such a target reflects the level of individual RNA molecules in the source. The optical or electrical signals resulting from the binding events from the DNA spots of the DNA chip after hybridization between the probe and the target represent the relative expression levels of the genes of the source.

The DNA chip could be used for differential gene expression between samples (e.g., healthy tissue versus diseased tissue) to search for various specific genes (e.g., connected with an infectious agent) or in gene polymorphism and expression analysis. Particularly, the DNA chip could be used to investigate expression of various genes connected with various diseases in order to find causes of these diseases and to enable accurate treatments.

Using embodiments of the invention, one could find a specific segment of a nucleic acid of a gene, i.e., find a site with a particular order of bases in the examined gene. This detection could be performed by using a diagnostic polynucleotide made up of short synthetically assembled single-chained complementary polynucleotides—a chain of bases organized in a mirror order to which the specific segment of the nucleic acid would attach (hybridize) via A-T or G-C bonds.

The practice of the embodiments of the invention may employ, unless otherwise indicated, conventional techniques of organic chemistry, polymer technology, molecular biology (including recombinant techniques), cell biology, biochemistry, and immunology, which are within the skill of the art. Such conventional techniques include polymer array synthesis, hybridization, ligation, detection of hybridization using a label. Specific illustrations of suitable techniques can be had by reference to the examples herein below. However, other equivalent conventional procedures can, of course, also be used.

The devices of the embodiments of the invention may be formed by any suitable means of manufacture, including semiconductor manufacturing methods, microforming processes, molding methods, material deposition methods, etc., or any suitable combination of such methods. In certain embodiments one or more of the microcoils, and circuitries may be formed via semiconductor manufacturing methods on a semiconductor substrate. Thin film coatings may be selectively deposited on portions of the substrate surface. Examples of suitable deposition techniques include vacuum sputtering, electron beam deposition, solution deposition, and chemical vapor deposition. The coatings may perform a variety of functions. For example, the coatings may be used to increase the hydrophilicity of a surface or to improve high temperature properties. Conductive coatings may be used to form the microcoils. Coatings may be used to provide a physical barrier on the surface, e.g. to retain fluid at specific sites on the surface.

In one embodiment of the invention, the substrate is made through combining two or more smaller substrates or solid support. Specifically, the fabricating of the fluidic zones, or the fabricating of the microcoils may involve combining two or more smaller substrates to form the substrate.

The substrate used in the embodiments of the invention may comprise various materials including, but not limited to silicon, glass, metal, and polymeric material. According to the embodiments, the substrate comprises an integrated circuit, a microarray, a macroarray, fluidic zones, a detector, a vibration element, or a combination thereof.

In on embodiment of the invention, the sample zone for holding a sample comprises a reservoir, a channel, an opening, a surface, or a combination thereof. According to another embodiment, the microcoil comprises of copper, aluminum, gold, silver, or a mixture thereof. The microcoil is placed near or adjacent to the fluidic zones.

The substrate of the embodiments of the present invention is suitable for forming openings, voids, surfaces, or microchannels thereon for holding fluid and fluidic communications. The sample zone may be open or closed along. Various methods may be used to form the sample zone on the substrate. For example, a reservoir or an open microchannel can be fabricated on a silicon substrate by etching methods known to those skilled in the art. Closed channels can be formed by sealing the open channels at top using methods such as anodic bonding of glass plates onto the open channels on the silicon substrate.

According to one embodiment of the invention, to fabricate a channel on a silicon substrate, a photoresist (positive or negative) is spun onto the silicon substrate. The photoresist is exposed to UV light through a high-resolution mask with the desired device patterns. After washing off the excessive unpolymerized photoresist, the silicon substrate is placed in a wet chemical etching bath that anisotropically etches the silicon in locations not protected by the photoresist. The result is a silicon substrate in which channels are etched. If desired, a glass cover slip is used to fully enclose the channels. Also, holes are drilled in the glass to allow fluidic access. For straighter edges and a deeper etch depth, deep reactive ion etching (DRIE) can be used as an alternative to wet chemical etching.

In another embodiment of the invention, channels may be formed on a silicon substrate using the following method. A seed layer of a metal, such as copper, is deposited over a surface of the substrate. Any suitable blanket deposition process may be used to deposit the seed layer of metal, such as physical vapor deposition (PVD), chemical vapor deposition (CVD), or other methods known to those skilled in the art. A layer of a sacrificial material, such as a dielectric material or a photoresist material, is then deposited over the seed layer. By removing the sacrificial material, for example using chemical etch process or thermal decomposition process, a number of trenches in the sacrificial layer are formed, and the seed layer is exposed in each of the trenches. Another layer of the metal, such as copper, is deposited over the exposed seed layer in the trenches. The metal layer extends over portions of the upper surface of the sacrificial layer; but gaps remain between the metal material layers extending from adjacent trenches and over the upper surface of the sacrificial layer. The sacrificial layer is removed, for example using chemical etching process or thermal decomposition process, and regions from which the sacrificial layer has been removed form channels in the metal layer. An additional layer of the metal is deposited over the upper surfaces of the metal layer to close the gaps over the channels.

In the embodiments of the invention, reservoirs, openings and channels can be made by using soft lithography method with suitable materials, such as silicon and polydimethylsiloxane (PDMS). With these techniques it is possible to generate patterns with critical dimensions as small as 30 nm. These techniques use transparent, elastomeric PDMS “stamps” with patterned relief on the surface to generate features. The stamps can be prepared by casting prepolymers against masters patterned by conventional lithographic techniques, as well as against other masters of interest. Several different techniques are known collectively as soft lithography. They are as described below:

Near-Field Phase Shift Lithography. A transparent PDMS phase mask with relief on its surface is placed in conformal contact with a layer of photoresist. Light passing through the stamp is modulated in the near-field. Features with dimensions between 40 and 100 nm are produced in photoresist at each phase edge.

Replica Molding. A PDMS stamp is cast against a conventionally patterned master. Polyurethane is then molded against the secondary PDMS master. In this way, multiple copies can be made without damaging the original master. The technique can replicate features as small as 30 nm.

Micromolding in Capillaries (MIMIC). Continuous channels are formed when a PDMS stamp is brought into conformal contact with a solid substrate. Capillary action fills the channels with a polymer precursor. The polymer is cured and the stamp is removed. MIMIC is able to generate features down to 1 μm in size.

Microtransfer Molding ((TM). A PDMS stamp is filled with a prepolymer or ceramic precursor and placed on a substrate. The material is cured and the stamp is removed. The technique generates features as small as 250 nm and is able to generate multilayer systems.

Solvent-assisted Microcontact Molding (SAMIM). A small amount of solvent is spread on a patterned PDMS stamp and the stamp is placed on a polymer, such as photoresist. The solvent swells the polymer and causes it to expand to fill the surface relief of the stamp. Features as small as 60 nm have been produced.

Microcontact Printing ((CP). An “ink” of alkanethiols is spread on a patterned PDMS stamp. The stamp is then brought into contact with the substrate, which can range from coinage metals to oxide layers. The thiol ink is transferred to the substrate where it forms a self-assembled monolayer that can act as a resist against etching. Features as small as 300 nm have been made in this way.

Techniques used in other groups include micromachining of silicon for microelectromechanical systems, and embossing of thermoplastic with patterned quartz. Unlike conventional lithography, these techniques are able to generate features on both curved and reflective substrates and rapidly pattern large areas. A variety of materials could be patterned using the above techniques, including metals and polymers. The methods complement and extend existing nanolithographic techniques and provide new routes to high-quality patterns and structures with feature sizes of about 30 nm.

Standard lithography on silicone wafer or silica glass could also be used to fabricate the devices of the embodiments of this invention. Reservoirs, openings and channels in the micrometer or nanometer scale can be fabricated from the devices. If fluidic flow is employed, it can be controlled by pressure gradient, electrical field gradient, gravity, and/or heat gradient. The surfaces of the fluidic zones and/or the diffusion barriers can be modified with polymers (polyethylene glycol (PEG)-dramatized compounds) that can minimize non-specific binding. The solid support can be inorganic material (e.g., glass, ceramic) or metal (e.g., aluminum). Biomolecules, proteins, antibodies, and/or nucleic acids can be coated on the surface of the substrate for specific analyte binding.

In the embodiments of the invention, the channels formed on the substrate may be straight or have angles or curves along their lengths. The characteristics and layout of the channels are determined by the specific applications the device is designed for. Although straight channels lining next to one another are a typical design for microfluidic devices, the channels in the embodiments of the invention may be designed in many different patterns to serve specific separation and detection requirements. Specifically, the design of the channels takes into consideration of the microcoils associated with the fluidic zones such that one or more microcoils are capable of generating excitation magnetic fields across at least a portion of one fluidic zones. Further, in the embodiments of the invention, the cross-section of the fluidic zone so formed may be uniform or vary along the channel's length, and may have various shapes, such as rectangle, circle, or polygon.

### EXAMPLE

Manufacture of the Device of an Embodiment of the Invention:

Standard micro-fabrication techniques could be used to make electrode sensor array plate, in which each physical location could be identified by a gold electrode pair, one of the electrode could be defined by x direction and the other by y direction. Each exposed electrode surface could be 10 microns in diameter and center to center distance for each electrode pair could be 80 microns; the distance between 2 adjacent electrode pairs (center to center) could 200 microns. The overall sensor surface could be 1 cm×2 cm with proper packaging and leads. In other words the sensor array could be similar to a CCD chip in terms of pixel and sensor element arrangement.

A separate channel network plate could be fabricated using chemical etching or injection molding or micromachining. The channel could be 100 microns wide and with a length of total 10 cm on the plate, etched from one side of the plate; antibodies against cardiac failure biomarkers, such as Troponin I, Creatine kinase, Creatine kinase-MB, Myoglobin, could be immobilized separately on the channel surfaces in given regions. The channel network plate could be transparent and used as optical waveguide for detection.

The sensor array plate and the channel plate could be then annealed by spin-coated glue to form a cardiac biomarker detection chip. The channel network of the chip would have a inlet and outlet, connected to a fluidic pump and waste reservoir.

Diagnostic Use of the Device of an Embodiment of the Invention for Risk Assessment:

(a) Priming: The chip could be first primed by buffer such as 1×PBS (phosphate buffer saline) containing 0.1% BSA (bovine serum albumin) and 0.01% triton. The conductivity of the buffer could be recorded by a computer through the electrodes exposed to the channels.

(b) A blood sample from a patient could be then introduced to the chip, the volume of the sample could be measured according to the edges of the sample passing through the channel and moving speed, the priming buffer could be also used to push the sample though the chip; all the liquids could be monitored according to conductivity differences. Biomarker molecules (analytes) could be captured by the immobilized antibodies.

(c) After washing with the priming buffer, a staining buffer (priming buffer plus labeled detection antibodies) could be introduced. Excitation light source (500 mW, 380 nm light) could be introduced through the waveguide (channel network substrate); fluorescent signals could be detected from regions where antibodies were immobilized. The rates of fluorescence signal increased could be recorded.

(d) A washing buffer (same as priming buffer) could be used to wash the channel, and signal changes for each detection regions could be recorded.

(e) A stripping buffer (0.1% triton, pH 10) could be then introduced and signal changes could be again recorded.

(f) Similarly, a standard sample (containing known amounts of analytes) could be processed in the same chip but a separate channel; the results can be used as reference for concentration calibration.

(g) By comparing the rates of signal increase and decrease for the sample volume measured, analytes concentration can then determined. Non-specific binding can be subtracted according to signal from non detection areas (no immobilized antibodies) and signal change rates.

The characteristics of some of the embodiments of the invention are illustrated in the Figures and examples, which are intended to be merely exemplary of the invention. This application discloses several numerical range limitations that support any range within the disclosed numerical ranges even though a precise range limitation is not stated verbatim in the specification because the embodiments of the invention could be practiced throughout the disclosed numerical ranges. Finally, the entire disclosure of the patents and publications referred in the application, if any, are hereby incorporated herein in entirety by reference.

1. A device comprising a channel comprising a plurality of sensors in a wall of the channel, wherein the sensors are located along a length of the channel and are configured to detect a leading edge and a trailing edge of a volume of a fluid flowing though the channel.

2. The device of claim 1, wherein the sensors comprise electrodes.

3. The device of claim 1, further comprising a binding surface on a portion of the wall of the channel and a detector in the vicinity of the wall of the channel, wherein the binding surface comprises molecules that bind to an analyte and the detector could be adapted to detect binding of the analyte to the binding surface.

4. The device of claim 3, wherein the detector is further adapted to detect detachment the analyte from the binding surface.

5. The device of claim 3, wherein the detector comprises an optical detector, a field effect transistor (FET) detector, an impedance detector, or an evanescent detector.

6. The device of claim 1, wherein the device comprises a plurality of channels connected in parallel or series.

7. The device of claim 6, wherein the plurality of channels are fabricated in a chip.

8. The device of claim 7, wherein the plurality of channels have a single inlet and a single outlet.

9. The device of claim 3, wherein the molecules on the binding surface are biomolecules.

10. The device of claim 9, wherein the biomolecules are DNA or RNA.

11. A method comprising flowing a volume of a fluid in a device comprising a channel comprising a plurality of sensors in a wall of the channel, wherein the sensors are located along a length of the channel, detecting a leading edge and a trailing edge of the volume of the fluid flowing though the channel, and determining the volume of the fluid flowing through the channel.

12. The method of claim 11, wherein the sensors comprise electrodes.

13. The method of claim 11, wherein the device further comprises a binding surface on a portion of the wall of the channel and a detector in the vicinity of the wall of the channel, wherein the binding surface comprises molecules that bind to an analyte, and the detector detects binding of the analyte to the binding surface.

14. The method of claim 13, wherein the detector further detects detachment the analyte from the binding surface

15. The method of claim 13, wherein the detector comprises an optical detector, a field effect transistor (FET) detector, an impedance detector, or an evanescent detector.

16. The method of claim 11, wherein the device comprises a plurality of channels connected in parallel or series.

17. The method of claim 11, wherein the plurality of channels are fabricated in a chip.

18. The method of claim 17, wherein the plurality of channels have a single inlet and a single outlet.

19. The method of claim 11, wherein the molecules on the binding surface are biomolecules.

20. The method of claim 19, wherein the biomolecules are DNA or RNA

21. The device of claim 3, wherein the binding surface is on a microarray located on the surface of the channel.
